(19) United States
(12) Patent Application Publication
(10) Pub. No.: US 2007/0276756 A1
(43) Pub. Date: Nov. 29, 2007

(54) Recording/Reproducing Device, Recording Medium Processing Device, Reproducing Device, Recording Medium, Contents Recording/Reproducing System, And Contents Recording/Reproducing Method

(76) Inventors: Kyoichi Terao, Saitama (JP); Toshio Suzuki, Saitama (JP); Kenichiro Tada, Saitama (JP)

Correspondence Address: YOUNG & THOMPSON, 745 SOUTH 23RD STREET, 2ND FLOOR, ARLINGTON, VA, 22202, US

(21) Appl. No.: 11/659,642

(22) PCT Filed: Aug. 4, 2005
(86) PCT No.: PCT/JP05/14300

§ 371 Date: Apr. 9, 2007

(30) Foreign Application Priority Data
Aug. 6, 2004 (JP) 2004-231552

(51) Int. Cl. G11B 20/10; G06Q 99/00

(52) U.S. Cl. 705/51

(57) ABSTRACT

A recording medium (240) has a protected region (241) where access limitation is set in advance and a non-protected region (242) where access is not limited. At least a part of a encryption key (20) and a part of an IV (21) that are required to encrypt contents data are written in the protected region (241).

### TECHNICAL FIELD

The present invention relates to a recording/reproducing apparatus, a recording medium processing apparatus, a reproducing apparatus, a recording medium, a content recording/reproducing system, and a content recording/reproducing method.

### BACKGROUND ART

There has been reported a technology for keeping content data confidential from a third party on an information recording/reproducing apparatus, such as a hard disk apparatus, for example (e.g. refer to a non-patent document 1).

According to the technology disclosed in the non-patent document 1 (hereinafter referred to as a “conventional technology”), it is possible to keep the content data confidential by encrypting the content data by using an encryption key and an initialize value (Initial Vector: hereinafter referred to as IV), as compared to the case where it is not encrypted.
Non-patent document 1: “Report of technology survey regarding block-cipher operation usable for confidentiality, message authenticity, and authenticated encryption”, [online], [Search on Jul. 30, 2004], Internet <URL:http://www.ipa.go.jp/security/enc/CRYPTREC/fy15/documents.mode_wg040607_{—}000.pdf>

### DISCLOSURE OF INVENTION

Subject to be Solved by the Invention

However, the conventional technology has the following problem.

The encryption key required for the encryption is protected, normally at such a security level that it cannot be easily accessed from the third party. However, the IV also required for the encryption is stored at a security level remarkably lower than that of the encryption key. Recently, hacking has shown a significant progress, and even from the fact that the IV can be obtained, we can easily imagine that the decipherment of a code will be dramatically increased. Namely, in the conventional technology, it is difficult to protect the content from the third party that intends to decipher a code to obtain the content.

It is therefore an object of the present invention to provide a recording/reproducing apparatus, a recording medium processing apparatus, a reproducing apparatus, a recording medium, a content recording/reproducing system, and a content recording/reproducing method, which can improve the confidentiality of the content.

Means for Solving the Subject

<Recording/Reproducing Apparatus>

The above object of the present invention can be achieved by a recording/reproducing apparatus for recording and reproducing content data onto a recording medium, via a recording medium processing device for recording the content data that is encrypted, into a non-protected area, the recording medium having a protected area in which access restriction is set and the non-protected area in which access restriction is not set, the recording/reproducing apparatus provided with: an encrypting device for encrypting the content data on the basis of an encryption key for encrypting the content data and an initial value for encrypting the content data together with the encryption key; a controlling device for controlling the recording medium processing device so as to write at least portion of the encryption key and at least portion of the initial value into the protected area; and a decrypting device for decrypting the encrypted content data on the basis of the at least portion of the encryption key and the at least portion of the initial value, recorded in the protected area.

In the present invention, the “protected area in which access restriction is set” indicates an area that can be accessed only by the equipment that is permitted to gain access in advance. Moreover, the expression “access restriction is not set” indicates an area which can be accessed even by equipment other than the equipment that is permitted to gain access.

According to the recording/reproducing apparatus of the present invention, in the operation thereof, the content data is encrypted by the encrypting device on the basis of the encryption key and the IV.

Here, the “content data” of the present invention indicates video data, such as movies, drama, and personally filmed video, image data, music data, and text data or the like, and indicates all the data that needs to be kept confidential from a third party, even slightly. Incidentally, in the present invention, the third party indicates those who maliciously try to decipher, decrypt, destroy or falsify the encrypted content data, or those who you do not want the content of the encrypted content data to be known to, with or without bad intensions, and it abstractly indicates all people that the owner of the encrypted content data or equivalent one do not permit to obtain, change, or browse it or perform similar actions. Therefore, for example, all the digital data treated in a general computer system can be the content data in the present invention.

The encryption key and the IV for encrypting the content data are based on predetermined types of encryption modes. The “predetermined types of encryption modes” herein include a CBC (Cipher Block Chaining) encryption mode, a CFB (Cipher Feedback) encryption mode, an OFB (Output Feedback) encryption mode, or an ABC (Accumulated Block Chaining) encryption mode, or the like, and indicate all the encryption modes for encrypting and decrypting the content data by using the encryption key and the IV.

The content data encrypted in accordance with the predetermined types of encryption modes is written into the non-protected area of the recording medium, for example, by the controlling device controlling the recording medium processing device. On the other hand, portion of the content data encrypted in this manner can be written into the protected area, for example. Moreover, not being encrypted in this manner, portion of the content data can be written into the protected area or the non-protected area.

The recording medium of the present invention has the protected area and the non-protected area in the recording area. The protected area indicates an area in which the access restriction is set, and the non-protected area indicates an area in which the access restriction is not set. As the recording medium having the protected area, there is listed a hard disk (HD) or the like, for example.

Moreover, the “recording medium processing device” is one of the equipment which is allowed in advance to access the protected area of the recording medium of the present invention, and it indicates the equipment which is constructed to write and read the data with respect to the recording medium. The recording medium processing device corresponds to a part or all of a hard disk drive (HDD) if the recording medium is a HD, for example. Namely, in the present invention, the recording medium and the recording medium processing device may be partially or entirely unified.

On the other hand, with regard to the encryption key used for the encryption, at least portion thereof is written by the recording medium processing device into the protected area that the third party cannot easily obtain. Therefore, even if the encrypted data is written in the non-protected area, the confidentiality of the encrypted content data is maintained to some degree. Here, the “at least portion” may be the whole of the encryption key (or the IV, described later).

Therefore, if the confidentiality of the IV is not considered at all, the confidentiality of the content data obviously deteriorates, as described above.

However, in the present invention, the controlling device controls the recording medium processing device so as to write at least portion of the IV into the protected area. Therefore, the third party cannot easily obtain even the IV, so that the confidentiality of the encrypted content data improves. Incidentally, the expression “the confidentiality improves” broadly indicates that the confidentiality is even slightly improved, as compared to the case where the IV is not written into the protected area.

Incidentally, on the recording/reproducing apparatus of the present invention, if the encrypting device, the decrypting device, and the controlling device need to access at least the protected area of the recording medium, the access permission is given. The access permission may be given at each time via a known authentication technique, or may be given in advance, for example.

Incidentally, for example, some authentication is preferably performed before the reading from the protected area of the recording medium, or before the writing into the protected area of the recording medium. However, even in that case, the authentication is not always necessary as long as the encryption key and the IV can be transferred while maintaining the confidentiality between the recording/reproducing apparatus, and the recording medium processing device and the recording medium. For example, if the recording medium, the recording medium processing device, and the recording/reproducing apparatus are mutually unified in advance, a highly secure interface may connect each two of the devices in advance. The highly secure interface herein indicates that an interface that is not a general bus, i.e. an ATA interface, gains access.

In particular, on the recording/reproducing apparatus of the present invention, the controlling device controls the recording medium processing device so as to write at least portion of the content data that is at least partially encrypted, into the non-protected area

By controlling it in this manner, the content data that is at least partially encrypted is entirely or partially written into the non-protected area. The encrypted content data often makes no sense as the data even if it is obtained by the third party because it is encrypted. On the other hand, the writing into the non-protected area has a lighter load of the process than that of the writing into the protected area, so that it is efficient.

In any cases, in the present invention, the encrypted content data is recorded into the non-protected area. At this time, all the encrypted content data may be recorded into the non-protected area, or at least portion of the encrypted content data may be recorded into the non-protected area. Namely, the case where the encrypted content data is recorded into the protected area to some degree, and the case where the content data that is not encrypted is recorded into the protected area or the non-protected area to some degree are not out of the technical scope of the present invention.

In one aspect of the recording/reproducing apparatus of the present invention, it is further provided with an authenticating device for obtaining access permission (or permission to access) to the protected area.

According to this aspect, it is provided with the authenticating device that obtains the access permission to the protected area, so that it is possible to prevent the third party from accessing the protected area with a high probability. Moreover, in the known authentication by the electronic certificate, and the authentication by the key pair of the private key and the public key, if the mutual authentication is performed (i.e. if the access permission is given), a temporal encryption key referred to as a session key is generated in some cases. If the encryption key and the IV are temporarily encrypted by the session key, the confidentiality of the encryption key and the IV improves during the reading process from the recording medium or the writing process onto the recording medium, so that it is secure.

Moreover, as in the HDD, for example, if the recording medium and the recording medium processing device are unified in advance, they may be regarded as one recording medium. In this case, the access permission may be given by the authentication or the like between the recording medium processing device and the encrypting/decrypting device.

In another aspect of the recording/reproducing apparatus of the present invention, the controlling device controls the recording medium processing device to write the at least portion of the encryption key and the at least portion of the initial value after writing the encrypted content data.

According to this aspect, under the control of the controlling device, at least portion of the encryption key and at least portion of the initial value are written by the recording medium processing device after writing the encrypted content data. Therefore, at least portion of the encryption key and the initial value used for the encryption can be certainly written into the protected area corresponding to the encrypted content data. However, at least portion of the encryption key and at least portion of the initial value can be also written before writing the encrypted content data.

In another aspect of the recording/reproducing apparatus of the present invention, the controlling device controls the recording medium processing device to write the at least portion of the encryption key and the at least portion of the initial value before writing the encrypted content data.

For example, in case that the encryption key and the IV are recorded after recording the encrypted content data, if the recording process of recording the content data stops due to unusual circumstances, such as power failure, a processing load for protecting the encryption key and the IV increases, so that it is not preferable. According to this aspect, the encryption key and the IV are recorded into the protected area before recording the encrypted content data, so that it is secure and the processing load is light, which is preferable. However, the effects of the present invention are ensured in any cases.

In another aspect of the recording/reproducing apparatus of the present invention, it is further provided with an encryption key generating device for generating the encryption key.

According to this aspect, it is provided with the encryption key generating device, so that it is possible to efficiently encrypt the content data.

In another aspect of the recording/reproducing apparatus of the present invention, it is further provided with an initial value generating device for generating the initial value.

According to this aspect, it is provided with the initial value generating device, so that it is possible to efficiently encrypt the content data.

In one aspect of the recording/reproducing apparatus provided with the initial value generating device, the content data is provided with a plurality of data blocks, each of which is a unit of the encryption, and the initial value generating device determines the initial value to have different values among at least portion of the data blocks.

In encrypting the content data, the content data to be encrypted is often divided into the plurality of data blocks. In this case, there is no problem even if each of the data blocks is encrypted by the same IV. However, according to this aspect, the initial value generating device determines the initial value to have different values among at least portion of the data blocks. Namely, the IV can be not a fixed value but a random number. Thus, the encrypted content data can further improve.

Moreover, in this aspect, the initial value generating device may generate a second initial value on the basis of (i) the initial value and (ii) a data located in a head of the data block.

According to this aspect, the initial value generating device generates the second IV on the basis of the IV recorded in the protected area and the data located in the head of each of the data blocks in the content data to be encrypted. In this case, the data portion used for the generation of the second IV is not encrypted, but the second IV can easily adopt a different value in each data block, so that it is preferable.

Moreover, in this aspect, the initial value generating device may generate a second initial value on the basis of the initial value and a data size of the encrypted content data or a block number of the data block.

According to this aspect, it is unnecessary to generate the second IV on the basis of the content data recorded in the non-protected area, so that it is preferable.

<Recording Medium Processing Apparatus>

The above object of the present invention can be also achieved by a recording medium processing apparatus for recording encrypted content data into a non-protected area on a recording medium, the recording medium having a protected area in which access restriction is set and the non-protected area in which access restriction is not set, the recording medium processing apparatus provided with: a writing device for writing at least portion of an encryption key for encrypting the content data and at least portion of an initial value for encrypting the content data together with the encryption key, into the protected area; and a reading device for reading the at least portion of the encryption key and the at least portion of the initial value, written into the protected area.

According to the recording medium processing apparatus of the present invention, at least portion of each of the encryption key and the IV is written into the protected area of the recording medium by the writing device. Namely, by the same operation as that of the above-mentioned recording medium processing device, it is possible to improve the confidentiality of the encrypted content data.

Incidentally, the recording medium processing apparatus of the present invention can adopt the same form as that of the already mentioned “recording medium processing device. Namely, it corresponds to a part or all of the hard disk drive (HDD) if the recording medium is the HD. Moreover, it can also adopt such a form as a removal hard disk drive.

In particular, on the recording medium processing apparatus of the present invention, the writing device writes at least portion of the content data that is at least partially encrypted, into the non-protected area of the recording medium, and the reading device reads at least portion of the encrypted content data that is written into the non-protected area of the recording medium.

All or part of the content data that is at least partially encrypted is written into the non-protected area by performing the writing or the reading in the above manner, so that the processing load can be reduced. In any case, in the present invention, the encrypted content data is recorded into the non-protected area. At this time, all the encrypted content data may be recorded into the non-protected area, or at least portion of the encrypted content data may be recorded into the non-protected area.

In one aspect of the recording medium processing apparatus of the present invention, it is further provided with an authenticating device for permitting equipment that instructs recording/reproduction of the encrypted content data to access to the protected area.

According to this aspect, the equipment that instructs the reproduction of the encrypted content data is permitted to access the protected area by the authenticating device. Therefore, it is possible to improve the confidentiality of the encrypted content data, extremely securely.

In another aspect of the recording medium processing apparatus of the present invention, it is further provided with an encryption key generating device for generating the encryption key.

According to this aspect, it is provided with the encryption key generating device, so that it is possible to reduce the load on the recording/reproducing apparatus side.

In another aspect of the recording medium processing apparatus of the present invention, it is further provided with an initial value generating device for generating the initial value.

According to this aspect, it is possible to reduce the load on the recording/reproducing apparatus side.

<Reproducing Apparatus>

The above object of the present invention can be also achieved by a reproducing apparatus for reproducing content data from a recording medium via a recording medium processing device for recording the content data that is encrypted, into a non-protected area, the recording medium having a protected area in which access restriction is set and the non-protected area in which access restriction is not set, the reproducing apparatus provided with: a controlling device for controlling the recording medium processing device (i) to read the encrypted content data from the non-protected area on the basis of an encryption key for encrypting the content data and an initial value for encrypting the content data together with the encryption key and (ii) to read at least portion of the encryption key and at least portion of the initial value from the protected area; and a decrypting device for decrypting the encrypted content data on the basis of the encryption key and the initial value.

According to the reproducing apparatus of the present invention, the encrypted content data, which is read from the non-protected area of the recording medium, is decrypted by the decrypting device by using the encryption key and the IV read from the protected area. Thus, it is possible to reproduce the content data while improving the confidentiality of the encrypted content data.

<Recording Medium>

The above object of the present invention can be also achieved by a recording medium having a recording area in which encrypted content data and an encryption key for encrypting the content data are recorded, the recording medium provided with: a protected area (i) which is formed in the recording area, (ii) in which access restriction is set under a special condition, and (iii) in which at least portion of the encryption key and at least portion of an initial value for encrypting the content data together with the encryption key are recorded; and a non-protected area (i-a) which is formed in the recording area, (ii-a) in which access restriction is not set, and (iii-a) in which the encrypted content data is recorded.

According to the recording medium of the present invention, at least portion of the encryption key and at least portion of the initial value are recorded into the protected area, so that it is possible to improve the confidentiality of the encrypted content data.

<Content Recording/Reproducing System>

The above object of the present invention can be also achieved by a content recording/reproducing system provided with: a recording medium processing device for (i) recording encrypted content data into a non-protected area and (ii) recording an encryption key for encrypting the content data and an initial value for encrypting the content data together with the encryption key, on a recording medium having a protected area in which access restriction is set and the non-protected area in which access restriction is not set; an encryption key generating device for generating the encryption key; an initial value generating device for generating the initial value; a controlling device for controlling the recording medium processing device so as to write at least portion of the encryption key and at least portion of the initial value into the protected area; an encrypting device for encrypting the content data on the basis of the encryption key and the initial value; and a decrypting device for decrypting the encrypted content data on the basis of the encryption key and the initial value.

According to the content recording/reproducing system of the present invention, in the operation thereof, the controlling device controls the recording medium processing device so as to write at least portion of the encryption key generated by the encryption key generating device and at least portion of the IV generated by the initial value generating device, into the protected area of the recording medium. Therefore, it is possible to improve the confidentiality of the content data encrypted by the encrypting device.

<Content Recording/Reproducing Method>

The above object of the present invention can be also achieved by a content recording/reproducing method of an apparatus for recording and reproducing encrypted content data on a recording medium having a protected area in which access restriction is set and a non-protected area in which access restriction is not set, the content recording/reproducing method, in recording the content data into the non-protected area, provided with: an encryption key generating process of generating an encryption key for encrypting the content data; an initial value generating process of generating an initial value for encrypting the content data together with the encryption key; an encrypting process of encrypting the content data on the basis of the encryption key and the initial value; a first writing process of writing the encrypted content data into the non-protected area; a second writing process of writing at least portion of the generated encryption key and at least portion of the generated initial value, into the protected area of the recording medium; and a decrypting process of decrypting the encrypted content data on the basis of the encryption key and the initial value.

According to the content recording/reproducing method of the present invention, it is possible to improve the confidentiality of the encrypted content data by virtue of the operation of each of the above-mentioned processes.

In one aspect of the content recording/reproducing method of the present invention, the content recording/reproducing method, in reproducing the encrypted content data from the recording medium, provided with: a first reading process of reading the encrypted content data from the non-protected area; and a second reading process of reading at least portion of the encryption key and at least portion of the initial value, from the protected area.

According to this aspect, the encryption key and the IV are read from the protected area, so that the encrypted content data can be securely reproduced.

As explained above, the recording/reproducing apparatus of the present invention is provided with the encrypting device, the decrypting device, and the controlling device, so that it is possible to improve the confidentiality of the encrypted content data. The recording medium processing apparatus of the present invention is provided with the writing device and the reading device, so that it is possible to improve the confidentiality of the encrypted content data. The reproducing apparatus of the present invention is provided with the controlling device and the decrypting device, so that it is possible to improve the confidentiality of the encrypted content data. The recording medium of the present invention is provided with the protected area and the non-protected area, so that it is possible to improve the confidentiality of the encrypted content data. The content recording/reproducing system of the present invention is provided with the recording medium processing device, the encryption key generating device, the initial value generating device, the encrypting device, the decrypting device, and the controlling device, so that it is possible to improve the confidentiality of the contents. The content recording/reproducing method of the present invention is provided with the recording medium processing process, the encryption key generating process, the initial value generating process, the encrypting process, the decrypting process, the first writing process, and the second writing process, so that it is possible to improve the confidentiality of the encrypted content data.

These effects and other advantages of the present invention will become more apparent from the following embodiments.

### BRIEF DESCRIPTION OF DRAWINGS

FIG. 1 is a block diagram showing a content recording/reproducing system in an embodiment of the present invention.

FIG. 2 is a schematic diagram showing a recording medium in the content recording reproducing system in FIG. 1.

FIG. 3 is a schematic diagram showing encrypted content data which is written onto the recording medium in FIG. 2.

FIG. 4 is a schematic diagram showing an encryption process of a CBC encryption mode.

FIG. 5 is a sequence chart showing an authentication process in the system in FIG. 1.

FIG. 6 is a sequence chart showing a content writing process in the system in FIG. 1.

FIG. 7 is a schematic diagram showing an encryption/recording process in FIG. 6.

FIG. 8 is a sequence chart showing a decrypting/reproduction process in a content recording/reproducing system in a second embodiment of the present invention.

FIG. 9 is a schematic diagram showing decrypting/reproduction process in FIG. 8.

FIG. 10 is a sequence chart showing the encryption/recording process in a content recording/reproducing system in a first modified example of the present invention.

FIG. 11 is a sequence chart showing the encryption/recording process in a content recording/reproducing system in a second modified example of the present invention.

FIG. 12 is a sequence chart showing the encryption/recording process in a content recording/reproducing system in a third modified example of the present invention.

### DESCRIPTION OF REFERENCE CODES

10 . . . content recording/reproducing system, 20 . . . encryption key, 21 . . . IV, 22 . . . encrypted content data, 100 . . . recording/reproducing apparatus, 110 . . . CPU, 120 . . . ROM, 130 . . . RAM, 140 . . . imaging processor, 200 . . . hard disk apparatus, 210 . . . authentication processor, 220 . . . memory, 230 . . . recording processor, 240 . . . recording medium, 241 . . . protected area, 242 . . . non-protected area

### BEST MODE FOR CARRYING OUT THE INVENTION

Hereinafter, the best mode for carrying out the present invention will be explained in each embodiment in order with reference to the drawings.

Hereinafter, the preferred embodiments of the present invention will be explained with reference to the drawings.

### First Embodiment

### Structure of Embodiment

Firstly, with reference to FIG. 1, the structure of the content recording/reproducing system in the embodiment of the present invention will be explained. FIG. 1 is a block diagram showing a content recording/reproducing system 10.

In FIG. 1, the content recording/reproducing system 10 is provided with: a recording/reproducing apparatus 100; and a hard disk apparatus (hard disk drive (hereinafter referred to as “HDD”) 200.

In FIG. 1, the recording/reproducing apparatus 100 is one example of the “recording/reproducing apparatus” of the present invention, which is constructed to encrypt various content data, such as images, video images, audio, music, and text, in a CBC encryption mode and record it onto the HDD 200, and also read the content data from the HDD 200 and decrypt it in the same encryption mode and reproduce it. The recording/reproducing apparatus 100 is provided with: a CPU (Central Processing Unit) 110; a ROM (Read Only Memory) 120; a RAM (Random Access Memory) 130; and an imaging processor 140.

The CPU 110 is one example of each of the “encryption key generating device”, the “initial value generating device”, the “encrypting device”, the “decrypting device”, and the “controlling device” of the present invention, which is constructed to be a control unit for controlling the operation of the recording/reproducing apparatus, and to perform a content protection process described later.

The ROM 120 is a read-only non-volatile memory, and stores therein a content protection program for the CPU 110 performing the content protection process.

The RAM 130 is a rewritable volatile memory and is constructed to temporarily store therein various data generated when the CPU 110 performs the content protection process.

The imaging processor 140 is constructed to generate output data to be outputted to a display apparatus and an audio output apparatus, which are not illustrated, on the basis of the content data, such as images and video images, recorded on the HDD 200.

The HDD 200 is one example of the “recording medium processing apparatus” or the “recording medium processing device” of the present invention, which is provided with: an authentication processor 210; a memory 220; a recording processor 230; and a recording medium 240.

The authentication processor 210 is a processing unit for performing mutual authentication with externally connected equipment, and it is one example of the “authenticating device” of the present invention. Incidentally, when the mutual authentication is performed, the above-mentioned CPU 110 also functions as another example of the authenticating device.

The memory 220 is a buffer for temporarily storing these various data groups when the various data is exchanged between the recording medium 240 and the recording/reproducing apparatus 100.

The recording processor 230 is one example of each of the “writing device” and the “reading device” of the present invention, which is constructed to write and read the encrypted content data on the recording medium 240, write and read an encryption key and an initial value described later, and further exchange the various data with the recording/reproducing apparatus 100.

The recording medium 240 is a hard disk, for example, and is one example of the “recording medium” of the present invention, which is constructed to store thereon the content data encrypted by the recording/reproducing apparatus 100 and the encryption key and the initial value generated by the recording/reproducing apparatus 100.

Next, with reference to FIG. 2, the detailed structure of the recording medium 240 will be explained. FIG. 2 is a schematic diagram showing the recording medium 240

In FIG. 2, the recording medium 240 has a protected area 241 and a non-protected 242 in the recording area. The protected area 241 is a recording area which cannot be accessed by equipment that is not mutually authenticated via the authentication processor 210, and it stores therein an encryption key 20 and an IV, which are one example of the “encryption key” and the “initial value” of the present invention, respectively. On the other hand, the non-protected area 242 is a recording area which can be accessed with or without the mutual authentication via the authentication processor 210, and it stores therein encrypted content data 22. Moreover, the protected area 241 may be accessed due to a special writing command and a special reading command, which are different from a writing command and a reading command to the non-protected area 242.

Next, with reference to FIG. 3, the detailed structure of the encrypted content data 22 will be explained. FIG. 3 is a schematic diagram showing the encrypted content data 22 to be recorded onto the recording medium 240.

In FIG. 3, the encrypted content data 22 is encrypted in a CBC encryption mode, and is provided with a plurality of CBC data blocks 220i (i=1, 2, . . . , n). Each of the CBC data blocks is encrypted on the basis of the encryption key 20 and the IV 21 generated by the recording/reproducing apparatus 100.

### Operation of Embodiment

Next, the operation of the content recording/reproducing system 10 will be explained.

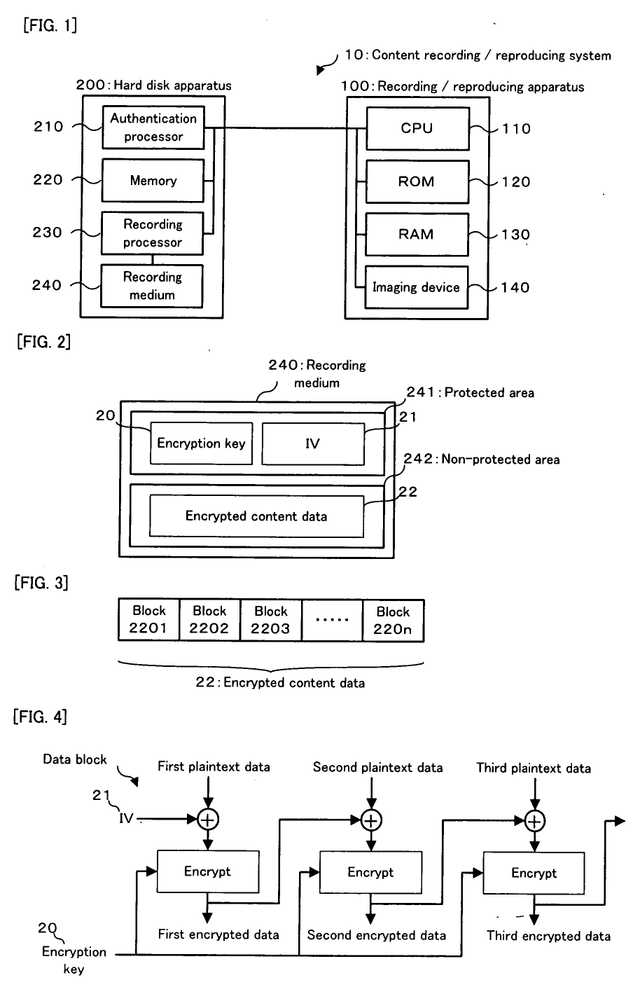

Firstly, with reference to FIG. 4, an explanation will be given for the encryption of the content data compliant with the CBC encryption mode in the embodiment. FIG. 4 is a schematic diagram showing an encryption process in the CBC encryption mode. Incidentally, FIG. 4 explains the encryption process with respect to an arbitrary data block constituting the content data before the encryption process.

In FIG. 4, each data block before encrypted is provided with a plurality of plaintext data. The plaintext data is data corresponding to the smallest data unit of the encryption in the CBC encryption mode. In the CBC encryption mode, the IV 21 is added to the plaintext data located in the head of each data block (i.e. the first plaintext data), and encrypted by the encryption key 20. The encrypted first plaintext data is first encrypted data.

Then, the first encrypted data is added to the second plaintext data and encrypted by the encryption key 20, to thereby become second encrypted data. Subsequently, in the same manner, the encrypted plaintext data is sequentially added to next plaintext data and encrypted. In the end, one encrypted CBC data block is generated by using all the encrypted data following the first encrypted data. Namely, in the CBC encryption mode in the embodiment, one data block is encrypted by one encryption key 20 and one IV 21.

Next, the content protection process will be explained. The content protection process is performed by that the CPU 110 of the recording/reproducing apparatus 100 executes the content protection program stored on the ROM 120. Incidentally, the content protection process is provided with: an authenticating process; and an encryption/recording process or a decrypting/reproduction process.

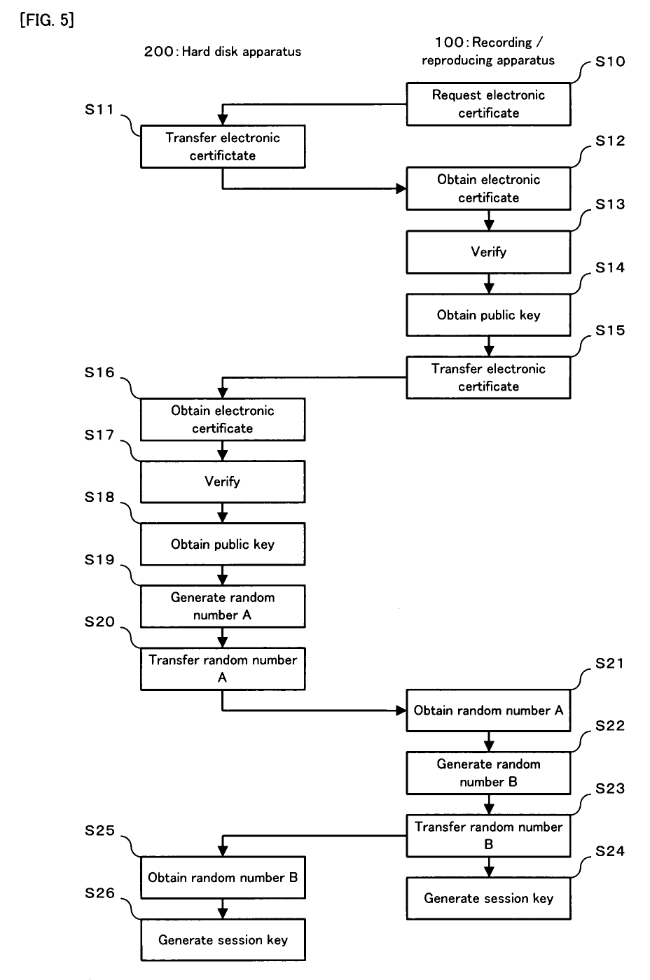

Firstly, with reference to FIG. 5, portion of the content protection process, i.e. the authenticating process, will be explained. FIG. 5 is a sequence chart showing the authenticating process. Incidentally, the authenticating process in this case indicates a process of performing the mutual authentication between the recording/reproducing apparatus 100 and the HDD 200, in order to store the encryption key 20 and the IV 21 into the protected area 241 of the recording medium 240. Incidentally, in the embodiment, it is assumed that both the recording/reproducing apparatus 100 and the HDD 200 already have an electronic certificate necessary for the mutual authentication, and a key pair of a public key and a private key.

In FIG. 5, firstly, the CPU 110 of the recording/reproducing apparatus 100 requests of the HDD 200 the electronic certificate (step S10). The authentication processor 210 transfers the electronic certificate stored in the memory 220 to the recording/reproducing apparatus 100, on the basis of the request (step S11).

The CPU 110 obtains the electronic certificate transferred from the HDD 200 (step S12), and performs a verification process (step S13). After it is verified that the electronic certificate is proper, then, the CPU 110 obtains the public key of the recording medium 240 or the HDD 200 included in the electronic certificate (step S14).

The electronic certificate issued from a certificate authority includes a certificate including the public key of the recording medium 240 or the HDD 200 and a signature on the certificate by the private key of the certificate authority. The public key obtained from the certificate authority in advance is recorded in the non-volatile memory area inside the recording medium 240 or the HDD 200.

The verification of the electronic certificate is performed by verifying the signature on the certificate by the private key of the certificate authority in the electronic certificate, by using the public key of the certificate authority. The verification is completed by confirming that the electronic certificate is properly signed by the certificate authority. The verification process is a known technique, so that the detailed explanation thereof is omitted.

After it is verified that the electronic certificate including the public key of the recording medium 240 or the HDD 200 in the electronic certificate is proper, the public key of the recording medium 240 or the HDD 200 is extracted. If obtaining the public key of the recording medium 240 or the HDD 200, the CPU 110 transfers the electronic certificate of the recording/reproducing apparatus 100 to the HDD 200 (step S15).

On the HDD 200, the authentication processor 210 obtains this electronic certificate (step S16), and performs the verification process, as described above (step S17). Then, the authentication processor 210 obtains the public key of the recording/reproducing apparatus 100 included in the electronic certificate (step S18).

After obtaining the public key of the recording/reproducing apparatus 100, the authentication processor 210 generates a random number A (step S19). The random number A varies at each time of the authentication process. The random number A is signed by the private key of the recording medium 240 or the HDD 200 and transferred to the recording/reproducing apparatus 100 (step S20).

On the recording/reproducing apparatus 100, the signature by the private key of the recording medium 240 or the HDD 200 is verified by using the previously obtained public key of the recording medium 240 or the HDD 200, to thereby obtain the random number A (step S21). Then, the CPU 110 generates a random number B (step S22). The random number B varies at each time of the authentication process. The CPU 110 signs the random number B by using the private key of the recording/reproducing apparatus 100 and transfers it to the HDD 200 (step S23). After finishing the transfer of the random number B, the CPU 110 generates a session key, which is a temporal encryption key 20, from the random number B and the obtained random number A (step S24), and stores it on the RAM 130.

In the meanwhile, on the HDD 200, the authentication processor 210 performs the verification process on the signature by the private key of the recording/reproducing apparatus 100, by using the already obtained public key of the recording/reproducing apparatus 100, and obtains the transferred random number B (step S25). The authentication processor 210 generates a session key from the random number A and the random number B, in the same manner as the CPU 110 does (step S26), and stores it into the memory 220.

In this manner, the mutual authentication between the recording/reproducing apparatus 100 and the HDD 200 is ended and the session key is shared. The shared session key is used for the encryption/recording process explained below.

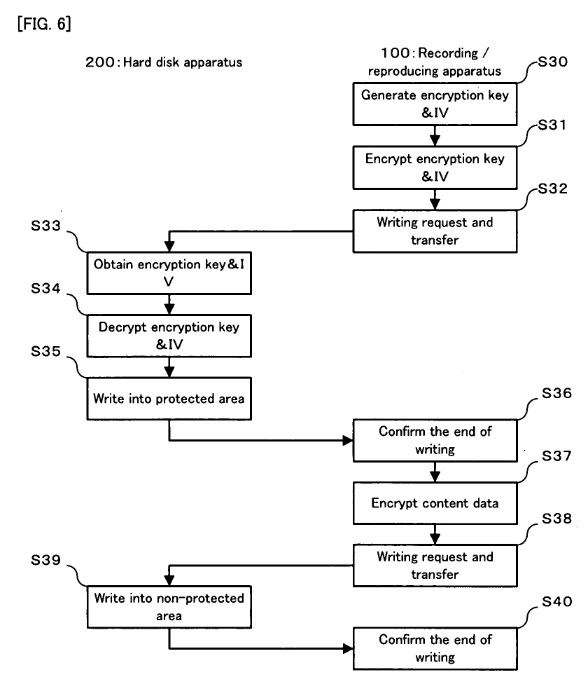

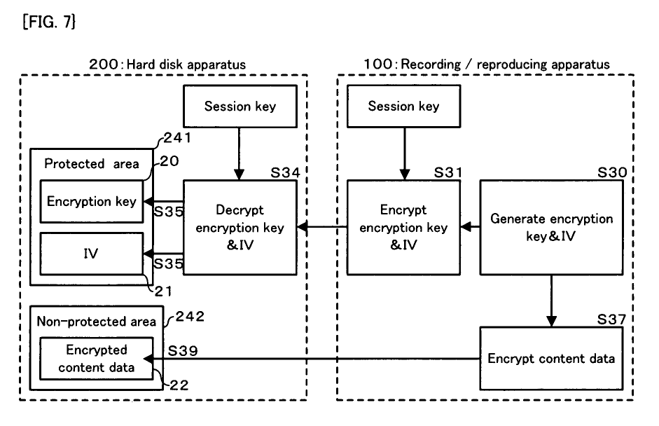

Next, with reference to FIG. 6 and FIG. 7, the encryption/recording process will be explained. FIG. 6 is a sequence chart showing the encryption/recording process. FIG. 7 is a schematic diagram showing the encryption/recording process. Incidentally, FIG. 7 is used to complement FIG. 6 and is referred to together with the explanation of FIG. 6. The individual explanation is omitted.

In FIG. 6, firstly, the CPU 110 of the recording/reproducing apparatus 100 generates the encryption key 20 and the IV 21 (step S30). For example, the recording/reproducing apparatus 100 is provided with a pseudo-random number generator, and a generated pseudo-random number is used as the encryption key 20 and the IV 21. With regard to a specific pseudo-random number generating method, the random number generation algorithm approved by NIST (the National Institute of Standards and Technology), for example. The pseudo-random number generator currently approved includes Appendices 3.1, 3.2 and Change Notice #1 in FIPS 180-2, ANSI X9.31 Appendix A.2.4, and ANSI X9.62-1998 Annex A.4, and the like.

After generating the encryption key 20 and the IV 21, the CPU 110 encrypts the encryption key 20 and the IV 21 by using the session key, which is generated in the above-mentioned authentication process and is temporarily stored in the RAM 130 (step S31).

After encrypting the encryption key 20 and the IV 21 by using the session key, the CPU 110 requests the HDD 200 to write the encryption key 20 and the IV 21 encrypted by using the session key into the protected area 241, and the CPU 110 transfers them to the HDD 200 (step S32).

In the present invention; the encryption key 20 and the IV 21 are recorded into the protected area 241 of the recording medium 240. Therefore, the highly secure data transfer is performed by using the session key which is generated in the authentication process and which is mutually shared between the recording/reproducing apparatus 100 and the HDD 200.

Incidentally, at this time, it is constructed to specify an address of the protected area 241 on the recording/reproducing apparatus 100 and to prepare for the data writing at the specified address, before the process in the step S32. Then, it is constructed such that when the writing request is obtained, the recording processor 230 writes the data (the encryption key 20 etc.) into the prepared address. Alternatively, it is constructed such that the address of the protected area 241 is not specified on the recording/reproducing apparatus 100 before the process in the step S32, and when the writing request is obtained, the recording processor 230 writes the data (the encryption key 20 etc.) into the protected area 241 that the recording processor 230 can manage. In this case, the ID of the data (the encryption key 20 etc.) or the like may be used to select the data in reading the protected area 241.

On the HDD 200, the authentication processor 210 obtains the transferred encryption key 20 and IV 21 (step S33). The authentication processor 210 decrypts the obtained encryption key 20 and IV 21, by using the session key temporarily stored in the memory 220 of the HDD 200 (step S34). The recording processor 230 writes the decrypted encryption key 20 and IV 21, into the specified address of the protected area 241 of the recording medium 240 or the place that the recording processor 230 can manage (step S35).

The CPU 110 of the recording/reproducing apparatus 100 confirms that the encryption key 20 and the IV 21 are written in the protected area 241 of the recording medium 240 (step S36), and encrypts the content data (step S37). After ending the encryption, the CPU 110 requests the HDD 200 to write the encrypted content data 22 into the non-protected area 242, and transfers the encrypted content data 22 to the HDD 200 (step S38).

In the present invention, the encrypted content data 22 is written into the non-protected area 242 of the recording medium 240. Therefore, as opposed to the case where it is written into the protected area 241, a special confidential process at this writing stage is not performed. For example, the request for the writing into the non-protected area 242 is made by using a “Write Sector Command” in terms of ATA standard. In this case, more specifically, the address of the non-protected area 242 and the size of the data to be written are firstly specified. On the HDD 200 side, the recording processor 230 prepares for the writing of the specified size of data into the specified address in the non-protected area 242 of the recording medium 240. The recording/reproducing apparatus 100 confirms the completion of the preparation and then transfers the data.

The recording processor 230 writes the transferred encrypted content data 22 into the non-protected area 242 (step S39). After the CPU 110 confirms that the encrypted content data 22 is written in the non-protected area 242 of the recording medium 240 (step S40), the encryption/recording process in the embodiment is ended.

Incidentally, the encryption key 20 and the IV 21 may be generated on the HDD 20. Even in that case, as in the same manner as described above, the generated encryption key 20 and IV 21 are encrypted by using the session key, and then transferred to the recording/reproducing apparatus 100.

Incidentally, in the embodiment, before the encrypted content data 22 is written into the non-protected area 242, the encryption key 20 and the IV 21 are written in the protected area. However, the encrypted content data 22 may be written before the writing of the encryption key 20 and the IV 21.

Incidentally, in the embodiment, in order to make the recording/reproducing apparatus 100 in the condition that “it is permitted to gain access in advance” in the present invention, the mutual authentication is performed between the recording/reproducing apparatus 100 and the HDD 20. However, the aspect to give the permission is not limited to the authentication as long as the proper equipment which can access the protected area can be recognized on the recording medium 240.

Moreover, in the embodiment, the session key is generated in the authentication process, and the data is securely exchanged between the equipment that is already permitted to gain access (the recording/reproducing apparatus 100) and the equipment on the recording medium 240 side (the HDD 200). However, as long as the data can be securely exchanged between them, the encryption using the session key is not always necessary. For example, the apparatus side (in this embodiment, the recording/reproducing apparatus) and the recording medium 240 side (in this embodiment, the HDD) may be unified in advance to gain the access in a method that does not use a general bus, e.g. ATA interface.

Moreover, in the above-mentioned embodiment, the IV 21 is generated and written into the protected area 241 of the recording medium 240, by the CPU 110 of the recording/reproducing apparatus 100. However, what is written into the protected area 241 may be portion of the IV 21.

### Second Embodiment

In the above-mentioned embodiment, the IV 21 generated by the recording/reproducing apparatus 100 is used as it is for the encryption of the content data. However, the IV used for the encryption of the content data may be different from this generated IV 21.

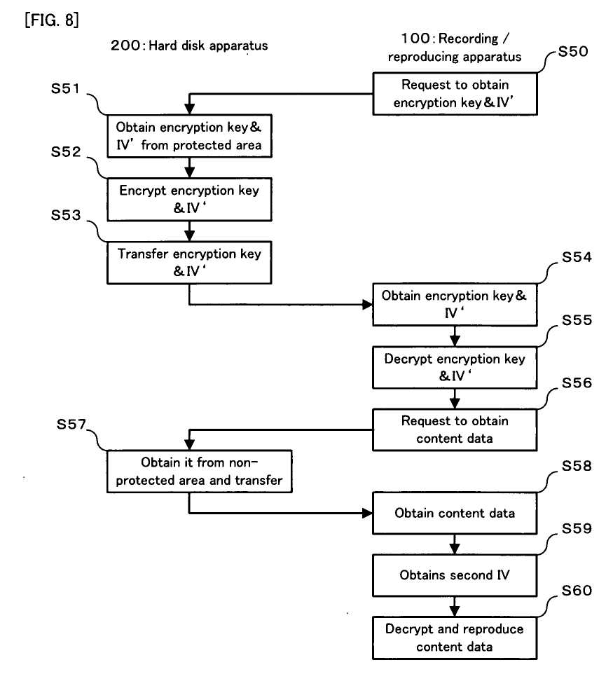

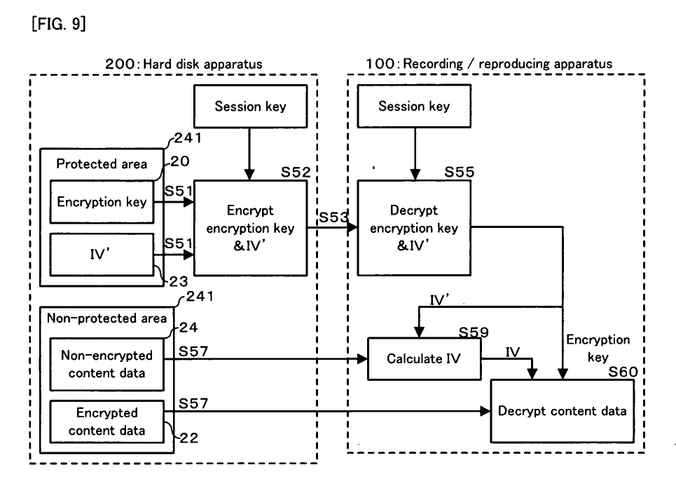

The second embodiment of the present invention will be explained with reference to FIG. 8 and FIG. 9. FIG. 8 is a sequence chart showing a decrypting/reproduction process in the second embodiment of the present invention. FIG. 9 is a schematic diagram showing the decrypting/reproduction process. Incidentally, FIG. 8 and FIG. 9 have the same concepts as those of FIG. 6 and FIG. 7, respectively. The steps and points repeating those in FIG. 6 and FIG. 7 carry the same numerical references, and their explanation will be omitted.

In FIG. 8 and FIG. 9, it is assumed that the already generated encryption key 20 and IV′ 23 are written in the protected area 241 of the recording medium 240 and that content data 24 which is not encrypted is written in the non-protected area 242 in addition to the encrypted content data 22.

The non-encrypted content data 24 indicates the plaintext data located in the head portion of each CBC data block, in the encryption procedure as shown in the first embodiment, for example. In the embodiment, an IV used for decryption (hereinafter referred to as a “second IV″, as occasion demands) is operated or calculated by the CPU 110 on the basis of the non-encrypted content data 24 and the IV′ 23. Incidentally, this embodiment explains the decrypting/reproduction process, but it is assumed that the encryption key 20 and the IV 21 (or the second IV) are common in both the encryption process and the decrypting process.

In FIG. 8, firstly, the CPU 110 of the recording/reproducing apparatus requests the obtainment of the encryption key 20 and the IV′ 23 (step S50). Incidentally, before the process in the step S50, the address of the protected area 241 is specified on the recording/reproducing apparatus 100, and preparation for the reading of the data of the specified address is performed on the HDD 200 side. Then, it is constructed such that when the obtainment request is received, the recording processor 230 reads the data (the encryption key 20 etc.) from the prepared address. In response to the obtainment request, the recording processor 230 reads and obtains the encryption key 20 and the IV′ 23 from the protected area 241 of the recording medium 240 (step S51). The recording processor 230 encrypts the obtained encryption key 20 and IV′ 23 by using the session key (step S52), and transfers them to the recording/reproducing apparatus 100 (step S53).

On the recording/reproducing apparatus 100, the CPU 110 obtains the transferred encryption key 20 and IV′ 23 (step 54), and temporarily stores them in the RAM 130, and also decrypts the encryption key 20 and the IV′ 23 by using the session key (step S55). After ending the decrypting, the CPU 110 temporarily stores the decrypted encryption key 20 and IV′ 23 in the RAM 130 and requests the HDD 200 to obtain the encrypted content data 22 and the non-encrypted content data 24 (step S56).

Here, in the present invention, the encrypted content data 22 and the non-encrypted content data 24 are written in the non-protected area 242 of the recording medium 240. Therefore, as opposed to the case where they are read from the protected area 241, a special confidential process at this reading stage is not performed. For example, the request for the writing into the non-protected area 242 is made by using a “Read Sector Command” in terms of ATA standard. In this case, more specifically, the address of the non-protected area 242 and the size of the data to be read are firstly specified. On the HDD 200 side, the recording processor 230 prepares for the reading of the specified size of data from the specified address in the non-protected area 242 of the recording medium 240.

If receiving the request to obtain the encrypted content data 22 and the non-encrypted content data 24, the recording processor 230 reads and obtains both the encrypted content data 22 and the non-encrypted content data 24, from the non-protected area 242 of the recording medium 240, and transfers them to the recording/reproducing apparatus 100 (step S57). On the recording/reproducing apparatus 100, the CPU 110 obtains the transferred encrypted content data 22 and non-encrypted content data 24 (step S58). The encrypted content data 22 and the non-encrypted content data 24 are temporarily stored in the RAM 130.

Then, the CPU 110 operates or calculates and generates the second IV necessary for the decrypting of the encrypted content data 22, on the basis of the non-encrypted content data 24 and the IV′23 and stored in the RAM 130 (step S59).

After generating the second IV, the CPU 110 decrypts the encrypted content data 22 on the basis of the encryption key 20 and the second IV, and controls the not-illustrated image processor 140 to thereby further generate display data and reproduce it via a not-illustrated display device or the like (step S60). Then, the decrypting/reproduction process in the second embodiment is ended.

According to the embodiment, it is possible to easily change the IV in each CBC block, to thereby further improve the confidentiality of the encrypted content data.

Incidentally, the generation aspect of the second IV in case that the IV′23 is written into the protected area 241 of the recording medium 240, as shown here, is not limited to the exemplification. For example, without using portion of the non-encrypted content data 24 written in the non-protected area 242, it is also possible to use the data size of the encrypted content data 22, the block number of the CBC block, or the like.

Incidentally, the embodiment uses, as the second IV, the calculation result based on the IV′ 23 stored in the protected area 241 and the non-encrypted content data 24 stored in the non-protected area 242. Of course, the initial value stored in the protected area 241 may be used as it is for the decrypting. In that case, as in the first embodiment, the content data stored in the non-protected area 242 may all be the encrypted content data 22.

### MODIFIED EXAMPLE

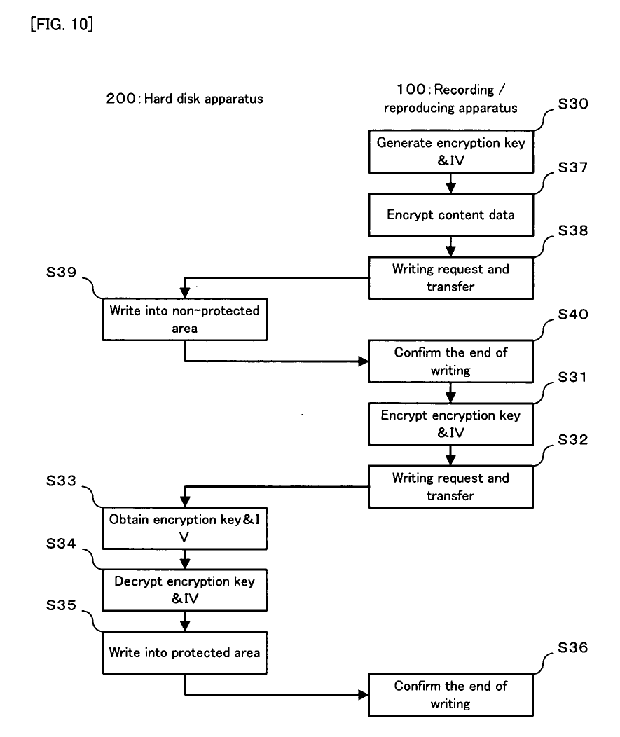

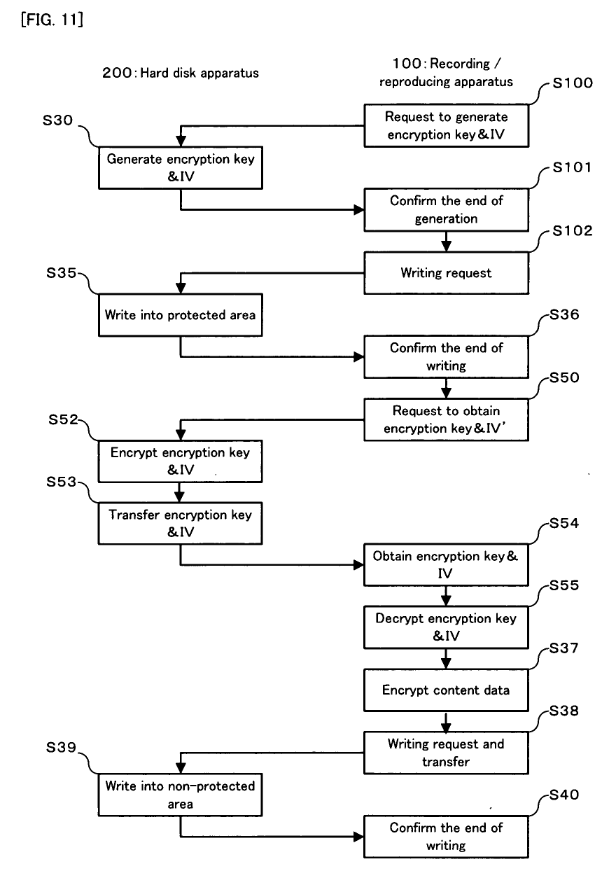

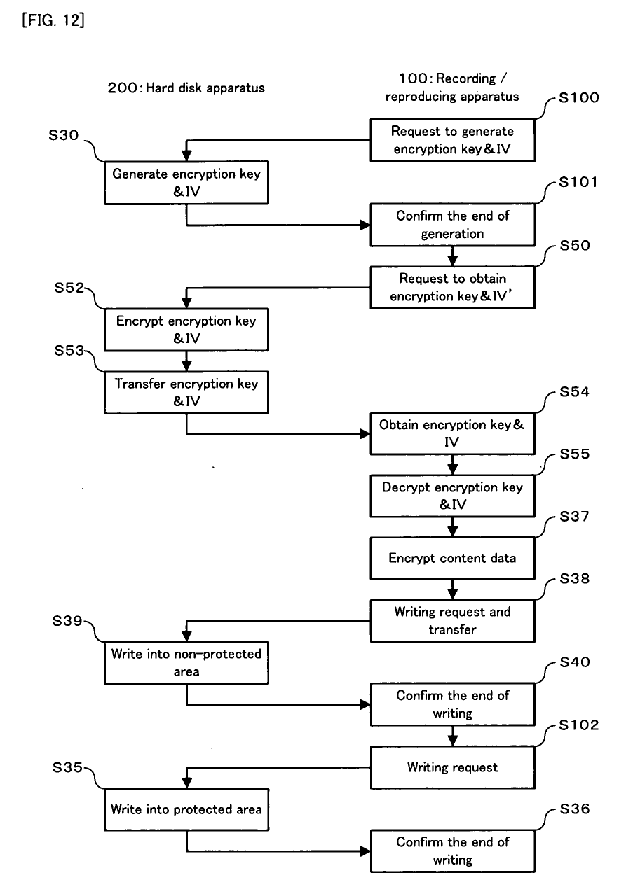

Next, other modified examples of the present invention will be explained with reference to FIG. 10 to FIG. 12. FIG. 10 is a sequence chart showing the encryption/recording process in a first modified example. FIG. 11 is a sequence chart showing the encryption/recording process in a second modified example. FIG. 12 is a sequence chart showing the encryption/recording process in a third modified example.

Incidentally, in each drawing of FIG. 10 to FIG. 12, the points repeating those in FIG. 6 and FIG. 8 carry the same numerical references, and their explanation will be omitted.

In FIG. 10, a step S37 to a step S40 are performed before the process in the step S31 to the step S36 in FIG. 6. Namely, in the encryption/recording process, the CPU 110 may write the encrypted content data 22 into the non-protected area 242 before writing the encryption key 20 and the IV 21 into the protected area 241.

In FIG. 11, firstly, the CPU 110 of the recording/reproducing apparatus 100 requests the HDD 200 to generate the encryption key 20 and the IV 21 (step S100). If the HDD 200 confirms the generation of the encryption key 20 and the IV 21 (step S101), the CPU 110 requests the writing of the generated encryption key 20 and IV 21 into the protected area (step S102). As described above, the encryption key 20 and the IV 21 may be generated not on the recording/reproducing apparatus 100 but on the HDD 200. Namely, the HDD 200 may be provided with the “encryption key generating device” and the “initial value generating device” of the present invention.

In FIG. 12, the processes in the step S50 to the step S40 are performed before the processes in the step S102 to the step S36 in FIG. 11. Namely, even if the encryption key 20 and the IV 21 are generated on the HDD 200, the encrypted content data 22 may be written into the non-protected area 242 before the encryption key 20 and the IV 21 are written into the protected area 241.

The present invention is not limited to the above-described embodiments, and various changes may be made, if desired, without departing from the essence or spirit of the invention which can be read from the claims and the entire specification. A recording/reproducing apparatus, a recording medium processing apparatus, a reproducing apparatus, a recording medium, a content recording/reproducing system, and a content recording/reproducing method in the present invention, which involve such changes, are also intended to be within the technical scope of the present invention.

### INDUSTRIAL APPLICABILITY

The recording/reproducing apparatus, the recording medium processing apparatus, the reproducing apparatus, the recording medium, the content recording/reproducing system, and the content recording/reproducing method of the present invention can be applied to keep the content data confidential from a third party on an information recording/reproducing apparatus, such as a hard disk apparatus, for example.

1-18. (canceled)

19. A recording/reproducing apparatus for recording and reproducing content data onto a recording medium, via a recording medium processing device for recording the content data that is encrypted, into a non-protected area, said recording medium having a protected area in which access restriction is set and the non-protected area in which access restriction is not set,
said recording/reproducing apparatus comprising:
an encrypting device for encrypting the content data on the basis of an encryption key for encrypting the content data and an initial value for encrypting the content data together with the encryption key;
a controlling device for controlling said recording medium processing device so as to write portion of the encryption key and portion of the initial value into the protected area before writing the encrypted content data; and
a decrypting device for decrypting the encrypted content data on the basis of the portion of the encryption key and the portion of the initial value, recorded in the protected area.

20. The recording/reproducing apparatus according to claim 19, further comprising an authenticating device for obtaining access permission to the protected area.

21. The recording/reproducing apparatus according to claim 19, further comprising an encryption key generating device for generating the encryption key.

22. The recording/reproducing apparatus according to claim 19, further comprising an initial value generating device for generating the initial value.

23. The recording/reproducing apparatus according to claim 22, wherein
the content data comprises a plurality of data blocks, each of which is a unit of the encryption, and
said initial value generating device determines the initial value to have different values among portion of the data blocks.

24. The recording/reproducing apparatus according to claim 23, wherein said initial value generating device generates a second initial value on the basis of the initial value and data located in a head of the data block.

25. The recording/reproducing apparatus according to claim 23, wherein said initial value generating device generates a second initial value on the basis of (i) the initial value and (ii) a data size of the encrypted content data or a block number of the data block.

26. A recording medium processing apparatus for recording encrypted content data into a non-protected area on a recording medium, said recording medium having a protected area in which access restriction is set and the non-protected area in which access restriction is not set,
said recording medium processing apparatus comprising:
a writing device for writing portion of an encryption key for encrypting the content data and portion of an initial value for encrypting the content data together with the encryption key, into the protected area before writing the encrypted content data; and a reading device for reading the portion of the encryption key and the portion of the initial value, written into the protected area.

27. The recording medium processing apparatus according to claim 26, further comprising an authenticating device for permitting equipment that instructs recording/reproduction of the encrypted content data to access to the protected area.

28. The recording medium processing apparatus according to claim 26, further comprising an encryption key generating device for generating the encryption key.

29. The recording medium processing apparatus according to claim 26, further comprising an initial value generating device for generating the initial value.

30. A recording medium having a recording area in which encrypted content data and an encryption key for encrypting the content data are recorded, said recording medium comprising:
a protected area (i) which is formed in the recording area, (ii) in which access restriction is set under a special condition, and (iii) in which portion of the encryption key and portion of an initial value for encrypting the content data together with the encryption key are recorded before the encrypted content data is written; and
a non-protected area (i-a) which is formed in the recording area, (ii-a) in which access restriction is not set, and (iii-a) in which the encrypted content data is recorded.

31. A content recording/reproducing system comprising:
a recording medium processing device for (i) recording encrypted content data into a non-protected area and (ii) recording an encryption key for encrypting the content data and an initial value for encrypting the content data together with the encryption key, on a recording medium having a protected area in which access restriction is set and the non-protected area in which access restriction is not set;
an encryption key generating device for generating the encryption key;
an initial value generating device for generating the initial value;
a controlling device for controlling said recording medium processing device so as to write portion of the encryption key and portion of the initial value into the protected area before writing the encrypted content data;
an encrypting device for encrypting the content data on the basis of the encryption key and the initial value; and
a decrypting device for decrypting the encrypted content data on the basis of the encryption key and the initial value.

32. A content recording/reproducing method of an apparatus for recording and reproducing encrypted content data on a recording medium having a protected area in which access restriction is set and a non-protected area in which access restriction is not set,
said content recording/reproducing method, in recording the content data into the non-protected area, comprising:
an encryption key generating process of generating an encryption key for encrypting the content data;
an initial value generating process of generating an initial value for encrypting the content data together with the encryption key;
an encrypting process of encrypting the content data on the basis of the encryption key and the initial value;
a first writing process of writing the encrypted content data into the non-protected area;
a second writing process of writing portion of the generated encryption key and portion of the generated initial value, into the protected area of the recording medium before writing the encrypted content data; and
a decrypting process of decrypting the encrypted content data on the basis of the encryption key and the initial value.

33. The content recording/reproducing method according to claim 32, said content recording/reproducing method, in reproducing the encrypted content data from said recording medium, comprising:
a first reading process of reading the encrypted content data from the non-protected area; and
a second reading process of reading portion of the encryption key and portion of the initial value, from the protected area.

34. The recording/reproducing apparatus according to claim 19, wherein
said recording/reproducing apparatus further comprises an encryption key/initial value encrypting device for encrypting the encryption key and the initial value by using a temporal session key generated in advance, and
said controlling device further controls said recording medium processing device to decrypt the encrypted encryption key and the encrypted initial value by using the session key, and to write portion of the decrypted encryption key and portion of the decrypted initial value before writing the encrypted content data.

35. The recording/reproducing apparatus according to claim 19, further comprising:
a judging device for judging whether or not preparation for writing the encrypted content data is ended on said recording medium processing device; and
a supplying device for supplying the encrypted content data to said recording medium processing device if the writing presentation is ended.
